(19) United States
(12) Patent Application Publication
(10) Pub. No.: US 2016/0001703 A1
(43) Pub. Date: Jan. 7, 2016

(54) ELECTRONIC DEVICE FOR ELIMINATING BLIND SPOTS IN AUTOMOTIVE VEHICLES

(71) Applicant: Rafael IULIANELLO, (US)

(72) Inventor: Rafael IULIANELLO, Bairro de Fátima-Serra (BR)

(21) Appl. No.: 14/769,004

(22) PCT Filed: Feb. 10, 2014
(86) PCT No.: PCT/BR2014/000048

§ 371 Date: Aug. 19, 2015

(30) Foreign Application Priority Data
Feb. 19, 2013 (BR) BR102013003791-5

(51) Int. Cl. B60R 1/00; H04N 5/232; G06K 9/62; H04N 7/18; H04N 5/247

(52) U.S. Cl. CPC B60R 1/00; H04N 7/18; H04N 5/247; G06K 9/6267; H04N 5/23238; B60R 2300/105; B60R 2300/303; B60R 2300/20; B60R 2300/8026

(57) ABSTRACT

ELECTRONIC DEVICE FOR ELIMINATING BLIND SPOTS IN AUTOMOTIVE VEHICLES, referring to a device which, upon installation on any automotive vehicle, eliminates blind spots on its rear mirrors (A), thus avoiding accidents, being constituted by micro cameras (1) installed on the rear mirrors, bumpers, rear windshield, truck, body and cuffs (handle edges) of the vehicles (A), aiming to capture images which are usually invisible to rear mirrors and send them to the driver of the vehicle by means of a screen (2) installed on the vehicle panel (B), to eliminate the so-called blind points, an element responsible for the development of the system which purpose is to provide and facilitate a clear view by means of the screen (2) by grouping images on its panel (B). It is also provided with the help of cameras (1) with infrared lighting resources, to allow for the capture of images in the dark, high sensitivity and great images of high definition at the viewing angle, so to provide better tranquility and safety for the driver and other people exposed to the risks of an accident.

The present invention refers to an electronic device for eliminating blind spots in automotive vehicles, a device which, once installed, will enable drivers of any kind of vehicle to increase its side or rear viewing angle. This system applies to any automotive vehicles, i. e.: cars, motorcycles, utility vehicles, buses, trucks, earthwork machines, agricultural machines, forklifts and others. It may be designed according to the model and design of each vehicle, so to obtain better visibility, capturing images of a new viewing angle (between 90° and 110°) and consequently sending real-time images with no distortion and constant visibility, by means of the monitor installed on the panel of the vehicle itself, with no need to look to the sides, giving the driver more time to take more reasonable decisions and allowing for safer actions.

### DESCRIPTION OF PRIOR ART

Vision is responsible for 90% of the required information for safe driving. Part of the accidents involving vehicles, pedestrians, motorcycles and bicycles occurs because, in a given moment, one of those elements is within the path of a vehicle but out of view for the driver. It is a non-visible area, popularly known as blind spot, responsible for 80% of accidents on our highways and roads. Additionally, the application of a dark film to cars, known as “Insulfilm”, has become a habit in our country, under the argument that people are not seen by possible thieves, being thus safer. This has caused more victims due to the reduction in visibility.

Despite the good ability in the use of resources as offered in the technical advancements so far by the automobile industry, especially in the field of vehicle project and design developments, a serious problem for drivers is still identified in all of the most widely produced models: the so-called “blind point” on the rear mirror.

According to the World Health Organization, 1.26 million deaths occur in traffic each year, most of which in poor and developing countries. In terms of safe driving, official statistics show thousands of deaths every year worldwide, and this figure is known to be underestimated, since it only considers deaths at the place of the accident. In the specific case of Brazil, the social cost of traffic accidents in the country's urban areas reaches the unacceptable amount of 5.6 billion Brazilian reals yearly, which is unbearable even for developed countries.

The literature relates risk factors to the human element (drivers and pedestrians), to the vehicle and to road and environmental conditions. Although there is no consistent and systematic research worldwide, it is generally accepted that man-related factors widely overcome the others.

To solve the above mentioned problems, the state of the art shows a few solutions, as disclosed below.

The system discloses that, when the vehicle is near an obstacle, a sound or lighting signal is issued, alerting for collision danger, and small cameras on the external rear mirrors, using the resource of infrared lighting, allow to capture images even in dark, with high sensitivity and great definition, installed at strategic points so not to deviate the driver's attention, and they will send real-time and constantly visible images with no distortion, by means of an image-grouping screen installed on the panel in front, with no need to look at the sides, thus providing more time for the driver to take more reasonable decisions and allowing for safer actions, fully solving the blind spot problem and keeping visibility even with “Insulfilm”, by acting as “eyes” for a new viewing angle (between 90° and 110°).

Optional items have also been devised, such as the installation of one additional camera on the rear windshield with the images on the screen coupled to its visor on the panel, helping the internal rear mirror in the vehicle. Another option is the installation of a small image recorder, capturing images for three days, which are automatically substituted after the third day, so to facilitate the analysis of an accident or even a theft, recording all the action.

On motorcycles, cameras will be installed on the cuffs (handle edges) as per the attached design, so to reach better visibility and record images from a new viewing angle (between 90° and 110°). By sending real-time images with no distortion, visibility is constant, by means of a monitor installed on the panel in front, with no need to look at the sides, allowing for safer actions.

The electronic device for eliminating blind spots in automotive vehicles will be disclosed according to the attached drawings, wherein:

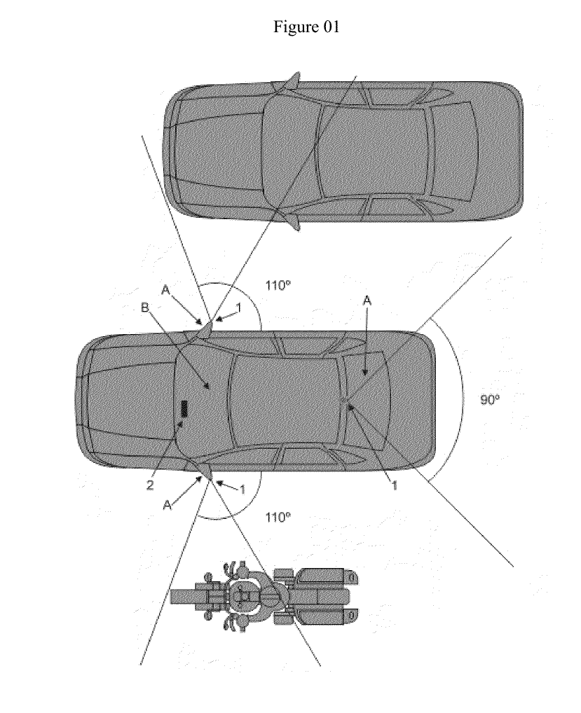

FIG. 1 is an upper view of a vehicle with electronic devices for eliminating blind spots in automotive vehicles installed on its rear mirrors, rear windshield and panel, with their respective viewing angles;

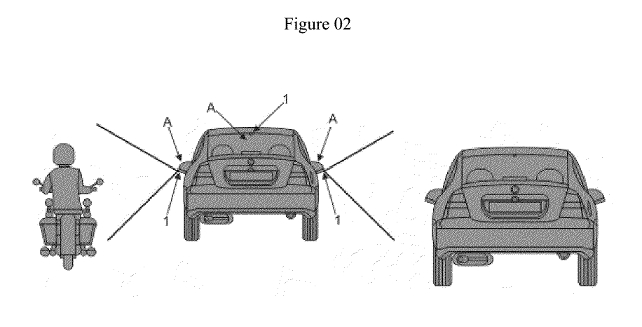

FIG. 2 is a rear view of a vehicle with the electronic device for eliminating blind spots in automotive vehicles installed on its rear mirrors and rear windshield;

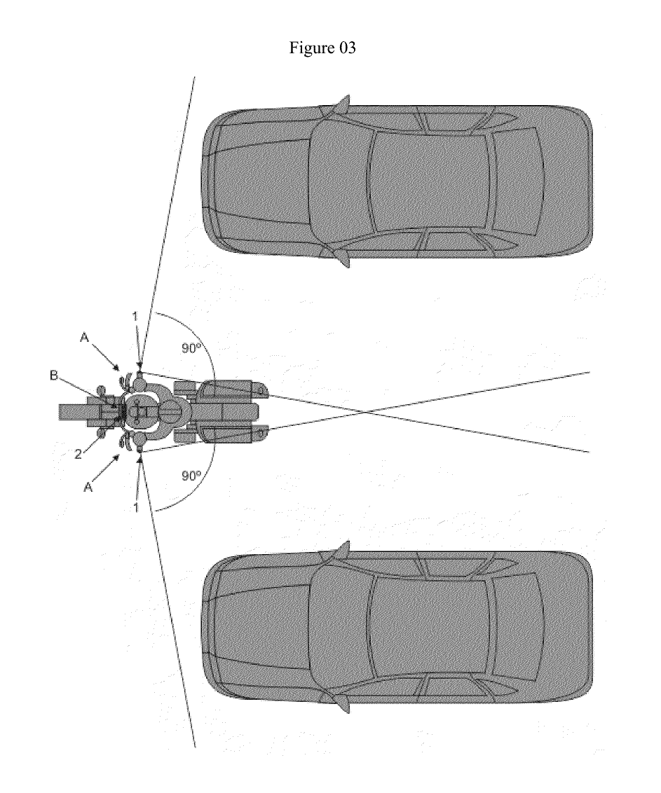

FIG. 3 is an upper view of a motorcycle with electronic devices for eliminating blind spots in automotive vehicles installed on the cuffs (handle edges) and on the panel, with two vehicles slightly behind it getting closer to the blind spot on its rear mirrors;

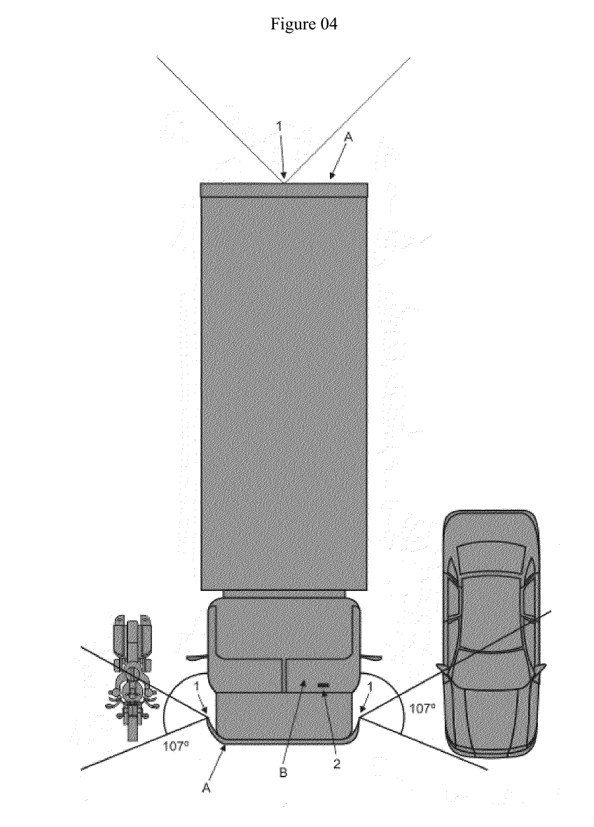

FIG. 4 is an upper view of a heavy vehicle with electronic devices for eliminating blind spots in automotive vehicles installed on its bumper, body and panel, with two vehicles in the blind spot of the rear mirror;

FIG. 5 is a front view of a heavy vehicle (tractor-truck and body) with the electronic device for eliminating blind spots in automotive vehicles installed on its bumper and panel;

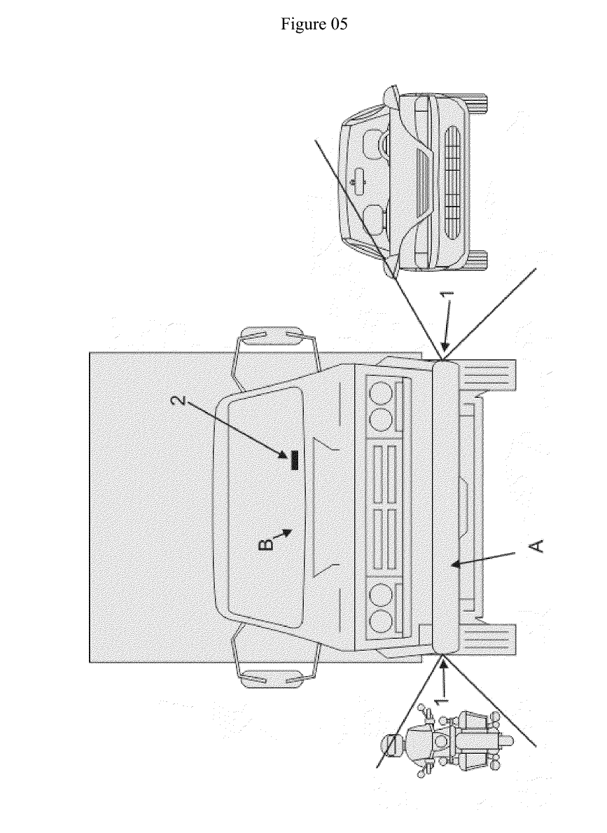

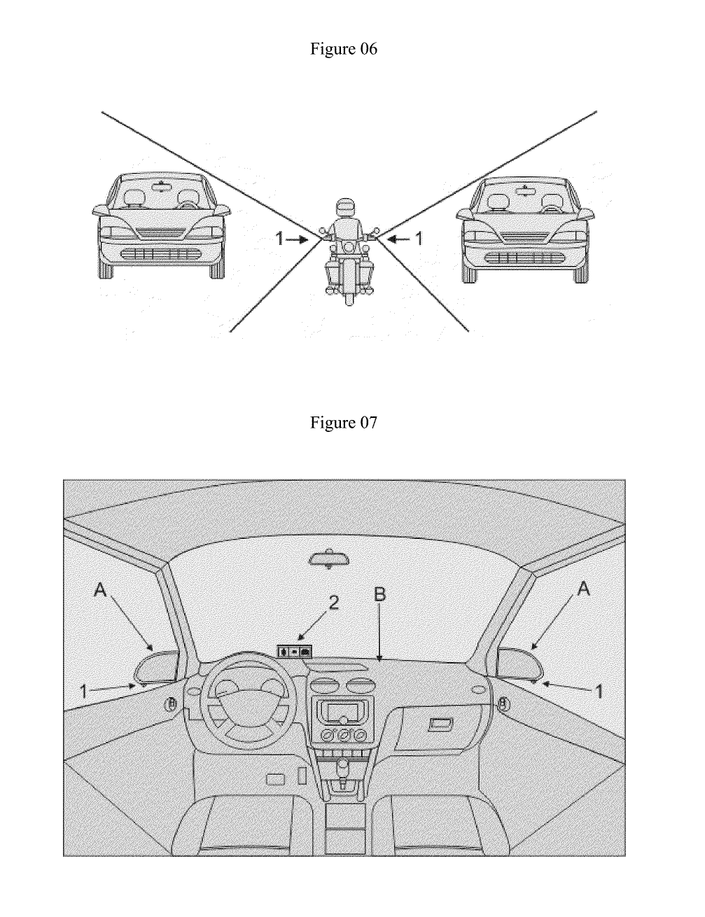

FIG. 6 is a front view of a motorcycle with the electronic device for eliminating blind spots in automotive vehicles installed on its cuffs (handle edges);

FIG. 7 is a view of the internal panel of a vehicle with the electronic device for eliminating blind spots in automotive vehicles installed on rear mirrors and on the panel, with the screen as an accessory embedded to the panel, highlighting the screen with grouped images on the screen, on which vehicles in the blind spot or nearby may be viewed;

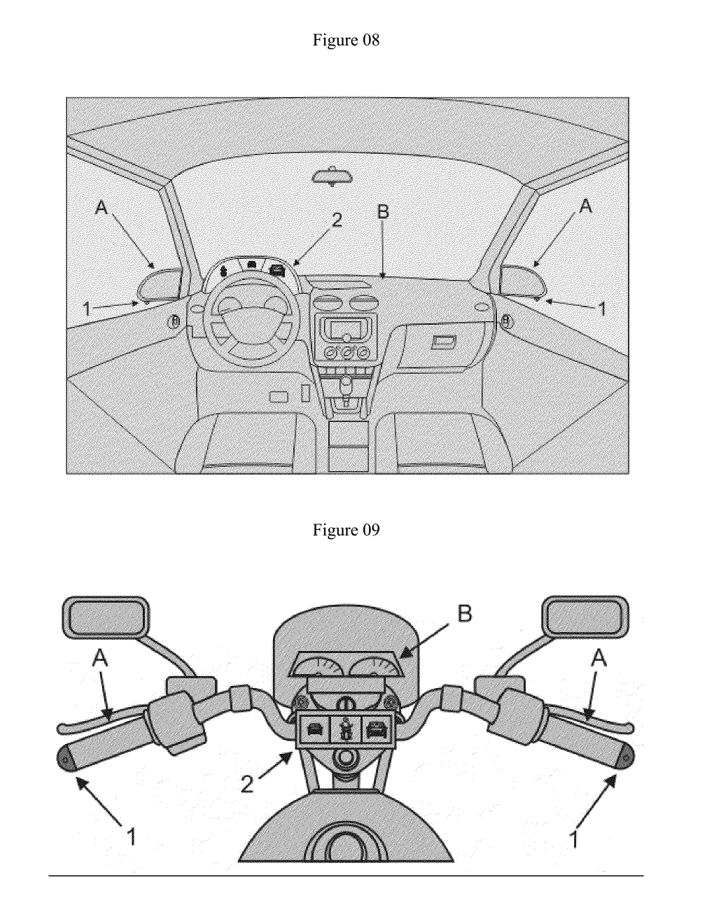

FIG. 8 is a view of the internal panel of a vehicle with the electronic device for eliminating blind spots in automotive vehicles installed on rear mirrors and the panel, with the screen as an accessory embedded to the panel, highlighting the screen with grouped images on screen, from which vehicles in the blind spot or nearby may be viewed; and

FIG. 9 is a view of the panel of a motorcycle with the electronic device, cameras for eliminating blind spots in automotive vehicles installed on cuffs (handle edges) and screen on the panel, highlighting the screen with grouped images on screen, from which vehicles in the blind spot or nearby may be viewed.

As we can see on the drawings, the electronic device for eliminating blind spots in automotive vehicles is an electronic device using a micro camera (1) installed on rear mirrors, bumpers, rear windshield, trunk, body and motorcycle cuffs (handle edges) (A), allowing to reach a wider view than the driver in its conventional driving position. The system is also provided with a video screen (2), installed on the vehicle panel (B) and easily seen by the driver, to enable him/her to see on that screen (2), when willing to pass a vehicle ahead or being passed, the real-time position and the possibility whether to safely pass or not the other vehicle, without the risks incurred by the conventional mode.

The electronic device for eliminating blind spots in automotive vehicles is a device using micro cameras (1) in its embodiment, installed at strategic points, so to reach a wider view than the conventional view of the driver in his/her conventional driving position.

All the images as captured by the micro camera (1) will be sent to a screen (2) installed on the panel of the vehicle (B), thus facilitating the view of the images as captured by said micro camera (1), wherein, by adopting this system, the driver will have a panoramic view of what is happening around his/her vehicle, motorcyclists using a corridor, etc., in a new viewing angle (between 90° and 110°).

Its embodiment is facilitated, since its constituents may be easily acquired in the market, making its cost become accessible to any level of consumer.

Those cameras (1) also have the resource of infrared lighting, allowing the capture of images in the dark, with high sensitivity and a great image with high definition at the viewing angle.

After capturing the images, these will be sent to screens (2) installed on the vehicle panel (B), in a position wherein the driver would usually look forward, taking as little of his/her attention to the traffic as possible, not only allowing for image visualization, but also for its storage, creating a kind of a “black box” which may also be used as evidence in judicial litigations or even to identify probable causes of traffic accidents, which use is optional.

The importance of the electronic device for eliminating blind spots in automotive vehicles enables more and more enhancements of systems and designs intended for safety. Therefore, products and services have been daily enhanced.

1. ELECTRONIC DEVICE FOR ELIMINATING BLIND SPOTS IN AUTOMOTIVE VEHICLES, characterized by providing micro cameras (1) on rear mirrors, bumpers, rear windshield, truck, body and cuffs of vehicles (A), aiming to capture images which are usually invisible to rear mirrors (A), sending them to the vehicle driver by means of a screen (2) installed on the vehicle panel (B).

2. ELECTRONIC DEVICE FOR ELIMINATING BLIND SPOTS IN AUTOMOTIVE VEHICLES of claim 1, characterized by micro cameras (1) provided on rear mirrors, bumpers, rear windshield, truck, body and cuffs (handle edges) of vehicles (A), sending them to the vehicle driver by means of the screen (2).

3. ELECTRONIC DEVICE FOR ELIMINATING BLIND SPOTS IN AUTOMOTIVE VEHICLES of claim 1, characterized by the screen (2) provided on the vehicle panel (B) providing drivers with an extra panoramic view of all vehicles around, thus avoiding the so-called blind spots.

4. ELECTRONIC DEVICE FOR ELIMINATING BLIND SPOTS IN AUTOMOTIVE VEHICLES of claim 1, characterized by grouping the images (2) as captured by the micro cameras (1), allowing to view occurrences outside the vehicle which are on the blind spots around it.
